(19) United States
(12) Patent Application Publication
(10) Pub. No.: US 2009/0167871 A1
(43) Pub. Date: Jul. 2, 2009

(54) INFORMATION RECORDING AND REPRODUCING DEVICE AND COPYING METHOD FOR BACKING UP INFORMATION

(75) Inventor: Shimpei USUI, Yokohama (JP)

Correspondence Address: MCDERMOTT WILL & EMERY LLP, 600 13TH STREET, N.W., WASHINGTON, DC, 20005-3096, US

(73) Assignee: HITACHI, LTD.

(21) Appl. No.: 12/338,609

(22) Filed: Dec. 18, 2008

(30) Foreign Application Priority Data
Dec. 28, 2007 (JP) 2007-340277

(51) Int. Cl. H04N 5/225

(52) U.S. Cl. 348/207.1; 348/E05.024

(57) ABSTRACT

An information recording and reproducing device for recording or reproducing one or more stream data blocks is arranged to have a setting unit for setting an operation mode about whether or not and how a backup data copy of one or more stream data blocks is created onto an external device and a generating unit for generating a script for executing a copy of only the backup data selected at the operation mode if the backup data copy is created onto the external device.

### INCORPORATION BY REFERENCE

The present application claims priority from Japanese application JP 2007-340277 filed on Dec. 28, 2007, the content of which is hereby incorporated by reference into this application.

### BACKGROUND OF THE INVENTION

The present invention relates to an information recording and reproducing device and a copying method for backing up information, and more particularly to the information recording and reproducing device such as a video camera or a digital camera which may be used as a detachable device.

The USB (Universal Serial Bus) has been published as the standards of a data transfer path to be used for connecting a personal computer and peripheral devices such as a mouse and a keyboard at relatively low cost and in more simple manner. Today, the USB is a standard interface for digital devices and is thus mounted in substantially any kind of personal computer. Since the USB is mounted in almost kinds of personal computers, their personal devices are likely to have the USB. For example, detachable external storage devices such as a USB memory are going to be made commercially available in the market.

The USB memory is equipped with a flash memory in itself. When the USB memory is connected with a personal computer or the like through a USB interface, the USB memory is recognized as a removable disk so that the USB memory may be accessed from the personal computer for the purpose of saving or viewing data stored therein. Further, the USB memory may store not only data but a software program such as a mailer for transferring and managing electronic mails.

On the other hand, the information recording and reproducing device such as a digital camera or a video camera uses a flash memory, a HDD (Hard Disk Drive), an optical disk and so forth as a medium for recording data. When copying data to be backed up, in order to use a recording medium not to be detached from the information recording and reproducing device, it is necessary to transfer data between the information recording and reproducing device and a personal computer through the USB interface. In general, when the information recording and reproducing device is connected with a personal computer through a USB cable, like the USB memory, the information recording and reproducing device is recognized as a removable disk by the personal computer connected therewith. Hence, the personal computer may access the information recording and reproducing device for the purpose for saving or viewing data.

Moreover, the data transfer technique has been embodied in many manners. For example, the U.S. Pat. No. 3,766,429 discloses a technique of causing a software program loaded in a personal computer to be automatically started so that the personal computer may access a recording device at a time when the storage device such as a USB memory is connected with the personal computer. The patent of JP-A-2006-319497 discloses a technique of causing image data stored in an information recording and reproducing device to be directly transferred to an external device without through a personal computer. The patent of JP-A-2006-24046 discloses a technique of causing data stored in an original folder preset in a data storage device to be transferred to a digital camera at a time when the digital camera is connected with the data storage device through the USB cable. Further, the Patent of JP-A-2004-9389 discloses a technique of causing a camera to be served as a user interface when the camera is directly communicated with a printer by connecting the camera with the printer through the USB cable. The patent of JP-A-2003-174610 discloses a technique of discriminating a means of communicating with an external device to be connected with an image pickup device and transferring the most approximate image data to the discriminated communicating means.

When backing up data stored in an information recording and reproducing device in a personal computer, an exclusive software program is used for the backup after the program is installed in the personal computer. The exclusive software program is ordinarily annexed with the information recording and reproducing device commercially sold in the market. This exclusive software program is referred to as a bundled software program.

Further, when the bundled software program is not installed in a personal computer, by using the function of the USB mass storage that is executed to recognize the information recording and reproducing device connected with the personal computer as a removable disk, the data stored in the information recording and reproducing device may be copied to the personal computer.

However, the use of the USB mass storage function only does not make it easy to specify a target data block desired by a user.

In order to back up data of still images or moving images recorded by a user, when the data is copied, it is necessary to specify a file in which a target data block is to be stored. However, ordinarily, file names are sequential in each recording scene. The user thus cannot specify the target data block on a file name. That is, the user cannot specify the target data block without representing the data blocks in a thumbnail manner or reproducing the target data block through the use of the bundled software program.

Further, even if a file name to be copied is grasped by a user, to reach the target file through the use of a file viewing function loaded in a personal computer, the user is required to execute a troublesome operation. Moreover, in order to copy files, the operation of selecting plural files is quite burdensome to the user.

Hereafter, the term “stream data” is used as a general expression. Concretely, the term “stream data block” corresponds to each scene imaged by an image pickup unit to be described later.

### SUMMARY OF THE INVENTION

It is therefore an object of the present invention to provide an information recording and reproducing device and a copying method for backing up information which are arranged to back up only the target data block stored in the information recording and reproducing device to be recognized as a detachable device by a personal computer.

According to an aspect of the invention, a device for recording and reproducing one or more stream data blocks includes a means for setting an operation mode about whether or not and how the backup copy of one or more stream data blocks is created onto an external device and a means for generating a script for executing a copy of the backup data only selected at the operation mode when the data is copied as the backup data onto the external device.

In operation, the stream data block desired to be backed up by a user can be automatically copied to the external device without through the user.

According to another aspect of the invention, a copying method for backing up data, installed in the device for recording and reproducing one or more stream data blocks includes the steps of setting an operation mode about whether or not and how the backup copy of one or more stream data blocks is created onto an external device and of generating a script for executing a copy of the backup data block only selected at the operation mode when copying the backup data block onto the external device.

In operation, the backup copy of the stream data can be automatically created onto the external device without through the user.

The present invention is effective in copying to a memory loaded in a personal computer the target data block only stored in the information recording and reproducing device to be recognized as a detachable device by the personal computer.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing functions of an information recording and reproducing device according to an embodiment of the present invention;

FIG. 2 is a block diagram showing software configurations of an information recording and reproducing device and a personal computer according to an embodiment of the present invention;

FIG. 3 is a table showing a device identification management table included in the embodiment;

FIG. 4 is a table showing a device identification management table included in the embodiment;

FIG. 5 is a table showing a copying management table included in the embodiment;

FIG. 6 is a view showing a screen displayed so that a user may select an operation mode;

FIG. 7 is a view showing a screen displayed so that a user may select a stream data block;

FIG. 8 is a flowchart showing a process of connecting an information recording and reproducing device with a personal computer;

FIG. 9 is a view showing a screen displayed on a monitor of a personal computer if a script file is stored in a recording medium loaded in the information recording and reproducing device;

FIG. 10 is a view showing a screen displayed on a monitor of a personal computer if no script file is stored in a recording medium loaded in the information recording and reproducing device;

FIG. 11 is a flowchart showing a process of generating a copying script;

FIG. 12 is a flowchart showing a process of generating a copying script;

FIG. 13 is a flowchart showing a process of disconnecting an information recording and reproducing device from a USB interface of a personal computer;

FIG. 14 is a flowchart showing a process of connecting an information recording and reproducing device with a personal computer through a USB interface if a copy of a selected scene is selected; and

FIG. 15 is a flowchart showing a process of connecting an information recording and reproducing device with a personal computer through a USB interface if a copy of an uncopied scene is selected.

### DESCRIPTION OF THE EMBODIMENTS

Hereafter, one embodiment of the present invention will be described in detail with reference to the appended drawings.

(1) Arrangement of Information Recording and Reproducing Device

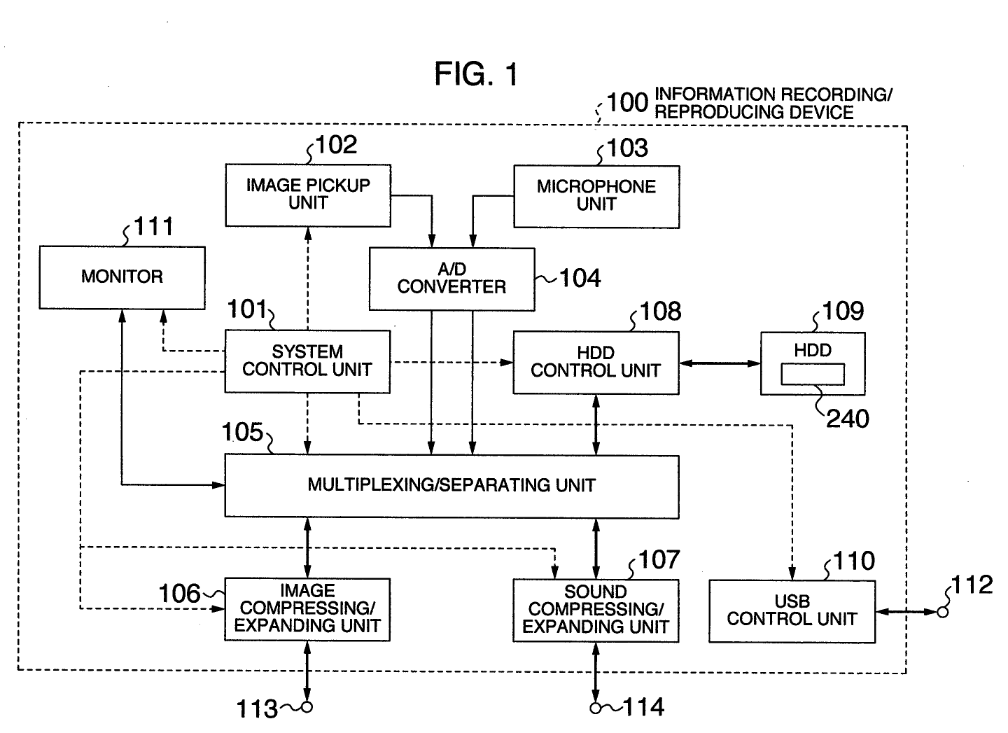

FIG. 1 is a block diagram showing a functional arrangement of an information recording and reproducing device. A real-line arrow denotes a direction of data and a broken-line arrow denotes a direction of control.

In FIG. 1, a numeral 100 denotes an information recording and reproducing device, which will be referred simply to as an information device. This information device 100 is arranged to have as main components a system control unit 101, an image pickup unit 102, a microphone unit 103, an A/D (analog-to-digital) converter unit 104, a multiplexing/separating unit 105, an image compressing and expanding unit 106, a sound compressing and expanding unit 107, a HDD (Hard Disk Drive) control unit 108, a HDD 109, a USB control unit 110, and a monitor 111.

The system control unit 101 controls the overall system of the information device 100.

Concretely, the system control unit 101 controls to execute the functional units 102 to 110.

The image pickup unit 102 executes a photoelectric conversion from an image of an object to be picked into image data. As the representative units, a CCD (Charge Coupled Device) or a CMOS (Complementary Metal Oxide Semiconductor) image sensor may be referred.

The microphone unit 10 performs a photoelectric conversion from a sound of an object to be picked into sound data.

The A/D converter unit 104 performs a digital conversion from the image data or the sound data picked by the image pickup unit 102 or the microphone unit 103 into digital data.

The multiplexing/separating unit 105 operates to transmit the digitized image data to the image compressing and expanding unit 106 and the digitized sound data into the sound compressing and expanding unit 107. The unit 106 compresses the digitized image data and the unit 107 compresses the digitized sound data. Then, the multiplexing/separating unit 105 operates to synchronize the digitized image data with the digitized sound data on time basis. As a result, the stream data 240 synthesized as one compressed data is generated. Further, the multiplexing/separating unit 105 operates to separate the synthesized stream data 240 into the digitized image data and the digitized sound data and then transmit the former data to the image compressing and expanding unit 106 and the latter data to the sound compressing and expanding unit 107. In addition, the stream data 240 includes still image data and moving image data. Finally, the stream data 240 is recorded in the information device 100.

The image compressing and expanding unit 106 operates to compress the digitized image data or expand the compressed digitized image data into the original digitized image data.

The sound compressing and expanding unit 107 performs an I/O (input/output) operation of the compressed or expanded sound data to the outside though an audio I/O terminal 114.

The HDD control unit 108 controls an amount of the stream data 240 to be stored in the HDD 109 and a storage timing on which the stream data 240 is to be stored in the HDD 109.

The HDD 109 stores files in which stream data 240 is stored and management information of the stream data 240.

The USB control unit 110 performs the USB communicating process with an external device such as a personal computer through an USB I/O terminal 112.

The monitor 111 operates to display an operation menu of the information device 100, the image data entered by the image pickup unit 102, and image information appearing when the stream data 240 recorded in the HDD 109 is reproduced.

The multiplexing/separating unit 105, the image compressing and expanding unit 106, the sound compressing and expanding unit 107 and the HDD control unit 108 may be arranged by hardware or by software. In the software arrangement, the proper programs are stored in the system control unit 101 so that those programs may execute the corresponding functions with those units.

A numeral 110 denotes a USB control unit, which controls the USB communications with an external device such as a personal computer.

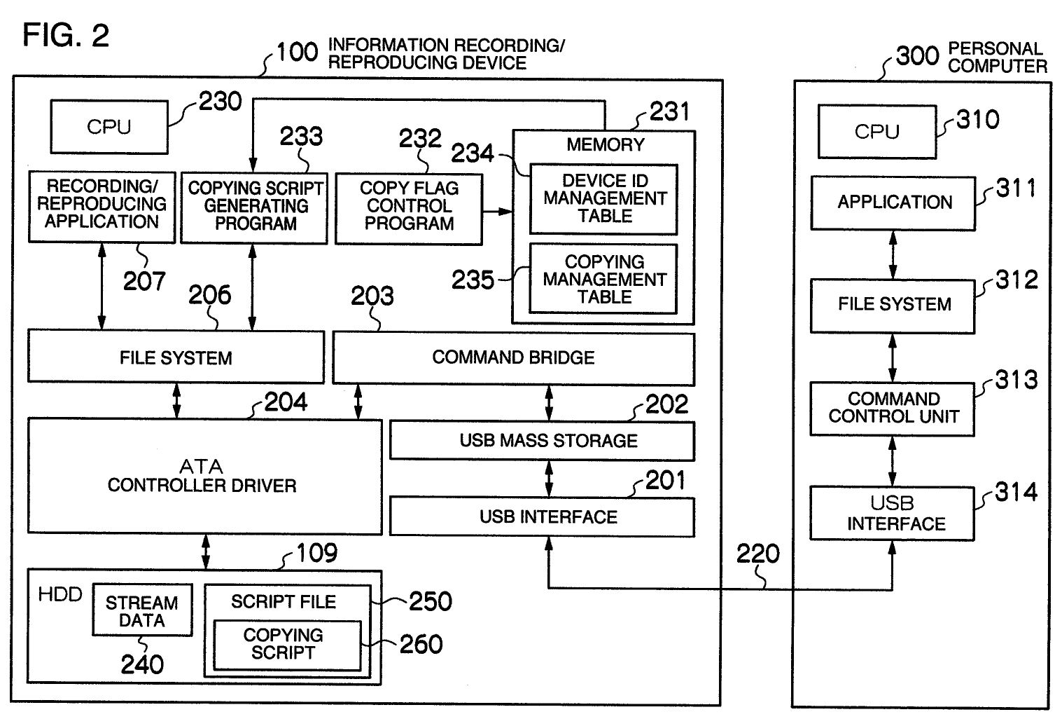

FIG. 2 is a block diagram showing a software arrangement of the information device 100. In the present invention, the information device 100 is treated as a USB device. Hence, the software arrangement of a personal computer 300 to be generally used as a USB host is described as well.

The information device 100 is arranged to have as main components a CPU 230 for executing various kinds of programs, a memory 231, a storing and reproducing application 207 for processing and storing the stream data 240 inside the information device 100 itself, a file system 206, an ATA controller driver 204 for bridging the file system 206 with the HDD 109 for storing the stream data 204, a command bridge 203 for converting ATA command into USB command or vice versa, a USB mass storage 202 for treating the information device 100 as a USB device, and a USB interface 201 for connecting with the personal computer 300 through a USB cable 220. (Hereafter, this connection will be referred to as a “USB connection” in noun form or “USB-connect” in verb form.)

Further, the information device 100 includes a program 233 for generating a copying script (to be discussed later) and a copy flag control program 232. These programs are executed to cause the information device 100 to automatically copy the user-selected stream data block 240 only to the personal computer 300 for the backup purpose.

The memory 231 stores a device identification management table 234 and a copying management table 235, both of which will be discussed later.

The HDD 109 stores the foregoing stream data block 240 and the script file 250. The script file 250 is used for obtaining a backup copy of the stream data block 240 optionally selected from the stream data stored in the HDD 109.

The script file 250 is generated when the CPU 230 starts the program 233 for generating a copying script (to be discussed later). The information device 100 is originally a sort of device not to be executed by the script. However, by storing the script file 250 in the information device 100, in response to an inquiry given from the personal computer 300, the information device 100 causes the USB control unit 108 to pseudoly give back to the personal computer 300 a response that this is a device (such as a CD-ROM) to be executed by the script to be automatically started.

Further, the copying script 260 is generated. To back up the desired data, this copying script 260 is executed for copying the stream data block 240 recorded in the information device 100 into the personal computer. Then, the copying script 260 is stored in the scrip file 260. This script 260 causes the stream data block 240 to be automatically copied into the personal computer 300 merely by connecting the information device 100 with the personal computer 300 through the USB cable 220.

Before connecting the information device 100 with the personal computer 300 through the USB interface 201, the information device 100 provides a capability of accessing the HDD 109 through the file system 206 and the ATA controller driver 204 in response to an instruction given from the storing and reproducing application 207.

On the other hand, after the connection through the USB interface 201, in the information device 100, the ATA command is sent from the HDD 109 to the command bridge 203 through the ATA controller drive 204, the command bridge 203 to convert the ATA command to the USB command, and then the USB command is sent to the external device through the USB mass storage 202 and the USB interface 201. When the external device makes access to the HDD 109 of the information device 100, in the information device 100, the USB command is read through the USB interface and is sent to the command bridge 203 through the USB mass storage 202. The converted ATA command makes it possible for the personal computer 300 to execute an access to the HDD 109 through the ATA controller driver 204.

The personal computer 300 is arranged to have as main components a CPU 310 for controlling various kinds of programs, an application 311, a file system 312, a command controller 313 for analyzing a USB command and executing the control based on the analyzed command, and a USB interface 3154.

Moreover, the command controller 313 needs to have a mass storage class driver. In particular, the command controller 313 is required to have a protocol supported by an information device to be connected and a subclass according to a command system.

The general connecting or disconnecting process between the USB device (the information device 100) and the USB host (the personal computer 300) will be briefly described hereafter.

The interrupt occurring in the connection of the USB device causes the USB host to recognize the USB connection. Then, the USB host performs an enumerating operation with respect to the connected device. This enumeration causes the USB device to supply information about various descriptors to the USB host. In response, the USB host performs the setting of a device address based on the obtained information and the setting of a configuration if necessary.

Afterwards, the USB host performs the connecting process with the class driver (USB mass storage 202) corresponding with the obtained device information and prepares the necessary communicating means to the data transfer of the concerned class. After the preparation of the data transfer, the data communication is started between the USB host and the USB device.

On the other hand, when the USB device is disconnected from the USB host, the following process is carried out. An interrupt occurring in the disconnection causes the USB host to recognize the disconnection of the USB device from the USB host. Then, the USB host cuts off the communicating means prepared for the data transfer with the USB device and then performs the post-process.

Then, the description will be oriented to a device identification management table 24 stored in the memory and a copying management table 235.

(2) Device Identification Management Table

A device identification management table 234 is a table for managing information for causing the personal computer 300 served as the USB host to recognize the information device 100 as a removable disk. Further, the device identification management table 234 holds a management table for each type of a device to be identified.

Concretely, the device identification management table 234 manages the contents of information to be transmitted in response to an inquiry command issued to the information device 100 by the personal computer when connecting the information device 100 with the personal computer 300 through the USB interface. The inquiry command is a command to be issued when the personal computer obtains information about a type and a configuration of a device.

The device identification management table 234 is composed of a “device identification item” column 2340, a “value” column 2341, the value of which is transmitted to the personal computer 300 as a response, and a “value meaning” column 2342.

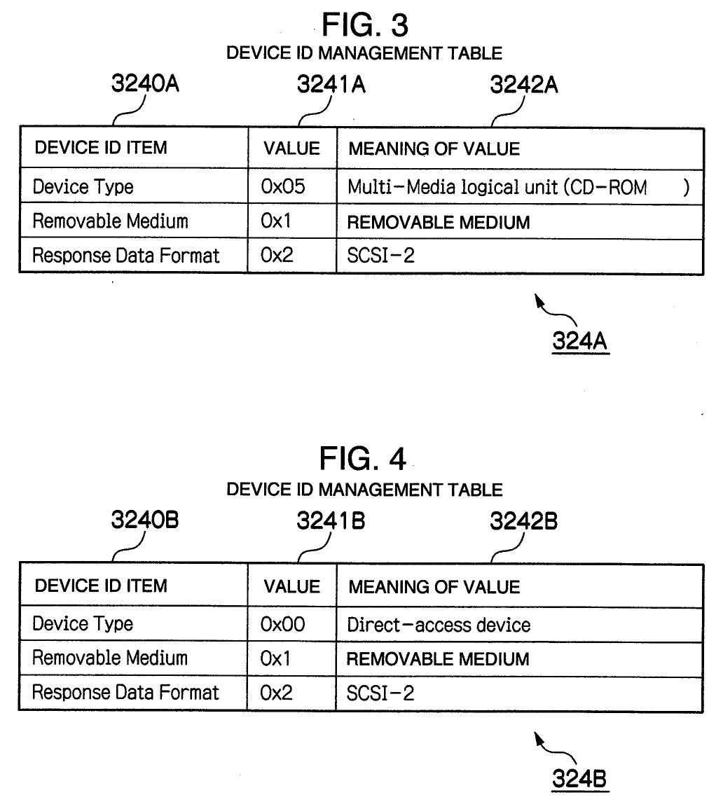

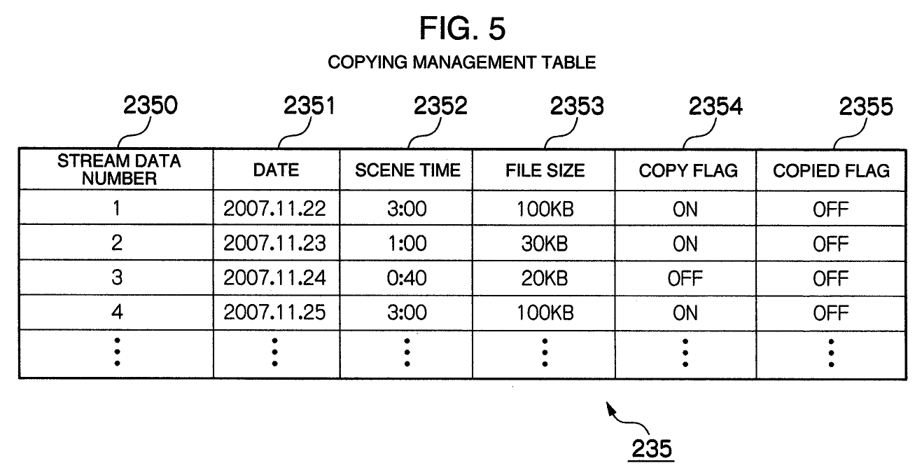

For example, FIGS. 3 and 4 illustrate exemplary information to be given back to the personal computer 300 by the information device 100 in response to the inquiry command.

The device identification management table 234A shown in FIG. 3 is a management table arranged so that the contents of the table cause the personal computer 300 to recognize the device as a CD-ROM. In response, the information device 100 operates to give back to the personal computer the identification information composed of a set of values “0x05”, “0x1” and “0x2” described in the “value” column 2341A.

The device identification management table 234A sown in FIG. 4 is a management table arranged so that the contents of the table cause the personal computer 300 to recognize the device as a HDD. Like the table shown in FIG. 3, in response, the information device 100 operates to give back to the personal computer 300 the identification information composed of a set of values “0x00”, “0x1” and “0x2” described in the “value” column 2341B.

(3) Copying Management Table

The copying management table 235 is a table for managing if the stream data block 240 stored in the HDD 109 has been copied in order that any stream data block 240 stored in the information device 100 may be automatically copied inside the personal computer 300 for the backup purpose.

The copying management table 235 is composed of a “stream data block number” column 2350 that indicates a management number of each obtained stream data block 240, a “date” column 2351 that indicates a date when each stream data block 240 is obtained in the information device 100, a “scene time” column that indicates a length of each concerned stream data block 240, a “size” column 2353 that indicates an amount of each concerned stream data block 240, a “copy flag” column 2354 that indicates if the concerned stream data block 240 is copied on the side of the personal computer 300 for the backup purpose, and a “copied flag” column 2355 that indicates if the backup copy is completed on the side of the personal computer 300.

Herein, in the “copy flag” column 2354, the information “ON” is stored if the backup copy of the stream data block 240 is desired, while the information “OFF” is stores if no backup copy is desired.

Further, in the “copied flag” column 2355, the information “ON” is stored if the backup copy of the stream data block 240 has been already obtained by the personal computer 300, while the information “OFF” is stored if it is not yet obtained.

(4) Setting of Operation Mode

In turn, the description will be oriented to the concrete process of setting the copying management table 235. This is the process of setting the operation mode to be set before USB-connecting the information device 100 with the personal computer 300.

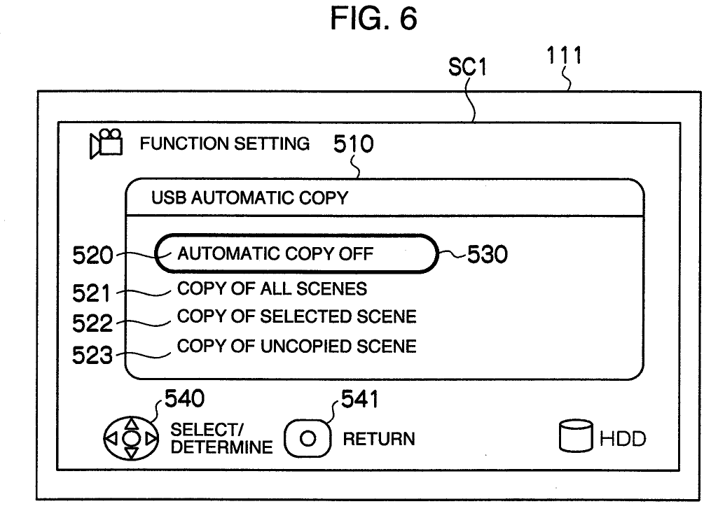

FIG. 6 shows a screen SCI about the setting of functions appearing on the monitor 111 of the information device 100, on which the user sets any stream data block 240 to be copied for the backup purpose.

The screen SCI is a screen on which the user can select if a backup copy is created and how a backup copy is created at his or her discretion.

The screen SCI includes a function setting dialogue 510, which is a dialogue for setting an operation mode of a backup copy. The function setting dialogue 510 is composed of an “automatic copy OFF” setting item 520, a “copy of all scenes” setting item 521, a “copy of a selected scene” setting item 522, and a “copy of an uncopied scene” setting item 523. The user can select one of those items.

The “automatic copy OFF” setting item 520 is an item in which no backup copy of the stream data 240 is required.

The “copy of all scenes” setting item 521 is an item in which a backup copy of all stream data blocks 240 stored in the HDD 109 is created.

The “copy of a selected scene” setting item 522 is an item in which a backup copy of only the stream data block 240 selected from all stream data blocks 240 by the user is created.

The “copy of an uncopied scene” setting item 523 is an item in which a backup copy of an uncopied stream data block(s) 240 of all stream data blocks 240 stored in the HDD 109 is created.

The user can select the item from those setting items 520 to 523 at his or her discretion by moving a select cursor 530.

The user can select or determine the item as moving the cursor on the setting items 520 to 523 vertically by depressing a select/determine icon 540.

A numeral 541 denotes a return icon, which is used for returning from the screen SCI about the function setting to one previous screen.

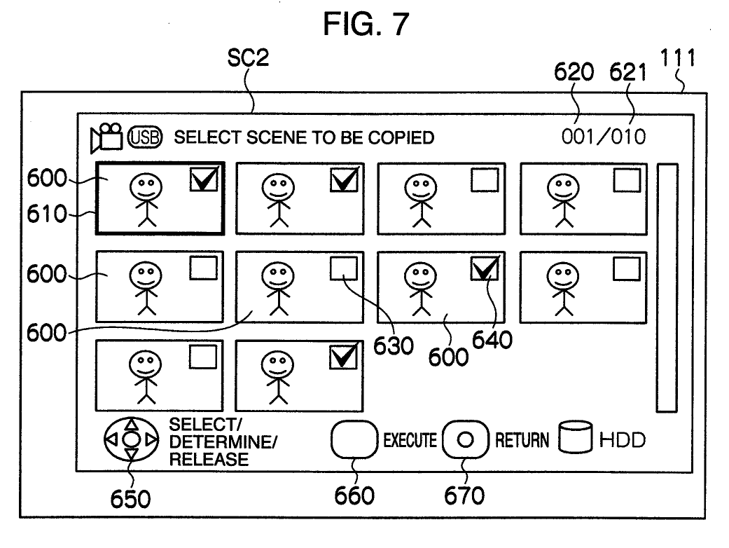

For example, when the user selects the “copy of a selected scene” setting item 522, if the user depresses the select/determine icon 540, the screen SC2 shown in FIG. 7 appears on the monitor 111.

On the screen SC2 are displayed all stream data blocks 240 stored in the HDD 109 in a thumbnail manner.

The select cursor 610 represents a thumbnail 600 being selected at this time.

A numeral 620 denotes a selected thumbnail number which is selected at this time by the select cursor 610. A numeral 621 denotes a total number of stream data blocks 240 to be recorded in the HDD 109 of the information device 100.

An unmarked check box 630 means that the thumbnail with this box 630 is not required to be copied for the backup purpose.

The check box 640 marked by the user denotes a thumbnail 600 to be automatically copied. The user can select the thumbnail 600 vertically and horizontally and determine or release the thumbnail 600 by depressing a select/determine/release icon 650 mounted on the information device 100.

A numeral 660 denotes an execution icon, which is used for prompting a backup copy of the stream data block 240 selected after the information device 100 shifts to the USB-connecting process to be executed on the side of the personal computer 300.

A return icon 670 is used for returning this screen SC2 to one previous screen.

As described above, when the user selects the “copy of all scenes” setting item 521 and the “copy of a selected scene” setting item 522, on the screen SC2 are displayed the thumbnails 600 of all stream data blocks 240 stored in the HDD 109.

When the user selects the “copy of an uncopied scene” setting item 523, only the stream data blocks 240 registered as the “OFF” representation in the “copied flag” column 2355 are displayed in a thumbnail manner.

When the user selects the “automatic copy OFF” setting item 520, the screen SC2 is not displayed and the screen SC1 about the function setting is finished.

When the information device 100 is USB-connected with the personal computer 300, the contents of the setting for automatic backup copy of data from the information device 100 to the personal computer 300 are not required to be the same at each connecting time.

As described above, if there exist plural stream data blocks 240 to be automatically copied for the backup purpose, the user can select his or her intentional operation mode for each stream data block.

(5) USB-Connecting Process

In turn, the description will be oriented to the flow of USB-connecting the information device 100 with the personal computer 300 according to the preset operation mode as described above.

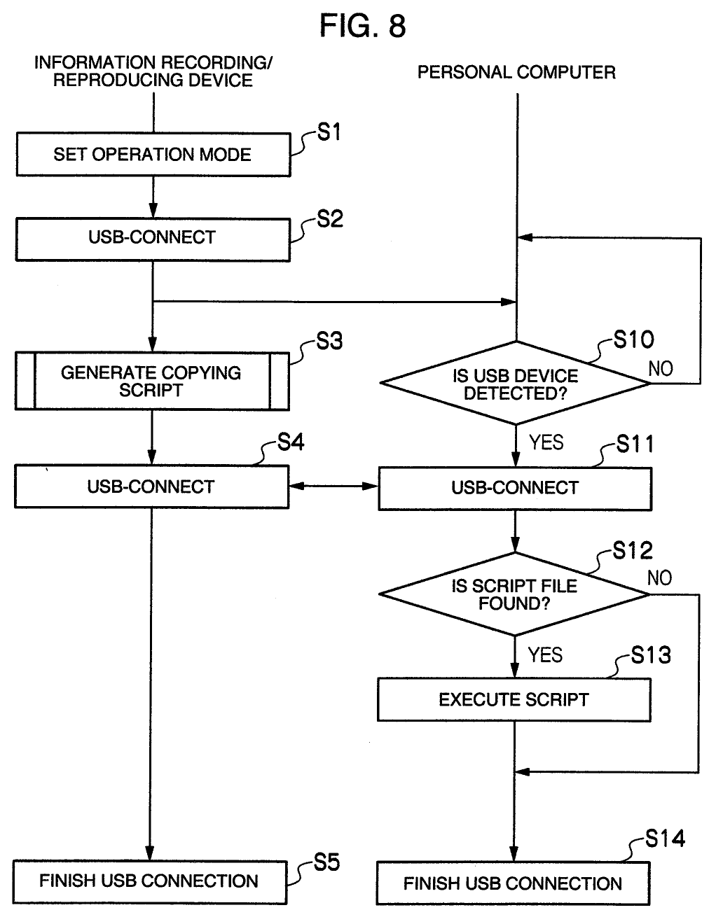

As shown in FIG. 8, at first, the user selects the operation mode and sets it according to the foregoing process. Then, based on the setting contents of the operation mode, the information device 100 operates to register the contents of the operation mode in the copying management table 235 (S1). Afterwards, the information device 100 operates to USB-connect with the personal computer 300 (S2).

Then, when the information device 100 makes sure that the interface 210 of the information device 100 is connected with the interface 314 of the personal computer 300, the information device 100 causes the personal computer 300 to automatically create the copying script 260 for creating a backup copy of any stream data block 240 (S3). The copying script 260 based on the setting of the operation mode is created in the script file 250 of the HDD 109.

Then, by plugging the USB cable 220 into the personal computer 300, the information device 100 performs the USB-connecting process (S4). In the USB-connecting process on the side of the information device 100, the information device 100 responds to an inquiry command sent from the personal computer 300. The contents of response include the values of the “value” column 3241 shown in FIG. 3 or 4. By transmitting these values to the personal computer 300, it is notified that the information device 100 is a device type corresponding with the value of the “value” column 3241. This notification enables the personal computer 300 to recognize the information device 100 as a removable disk.

Then, the information device 100 finishes the USB-connecting process (S5).

On the other hand, the personal computer 300 regularly detects if a USB device (removable disk) is connected therewith (No in S10).

When the information device 100 is USB-connected with the personal computer (S2), if the personal computer 300 detects the USB device (Yes in S10), the personal computer 300 starts the USB-connecting process (S11). On the side of the personal computer 300, the USB-connecting process is executed to cause the personal computer 300 to transmit an inquiry command to the information device 100.

In response to the inquiry command from the information device 100, the personal computer 300 opens a route folder displayed on the screen and determines if a script file 250 is found (S12).

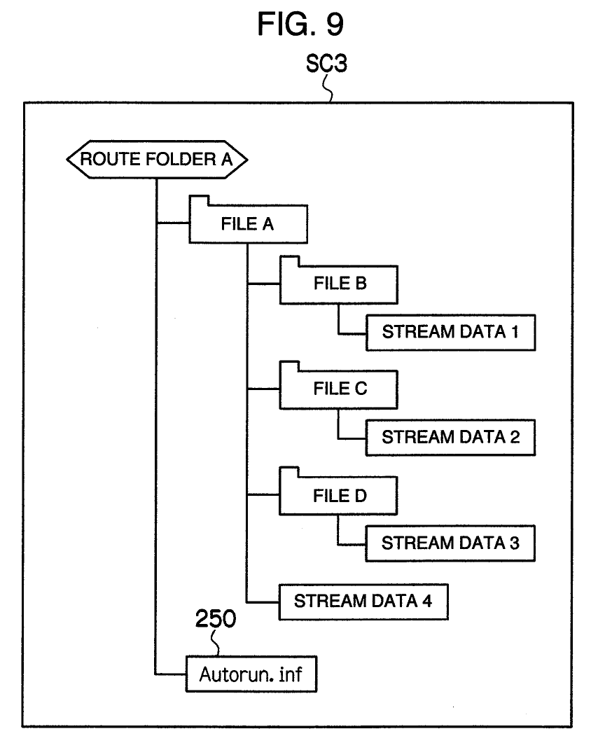

For example, FIG. 9 shows a route folder A opened by the personal computer 300. The route folder A concerns with the case that the user of the personal computer recognizes on the screen SC3 that a removable disk is connected to the personal computer 300. The user of the personal computer 300 can check that a script file “Autorun.inf” for storing the copying script is saved in addition to the stream data blocks 1 to 4 saved in the ordinary files A to D.

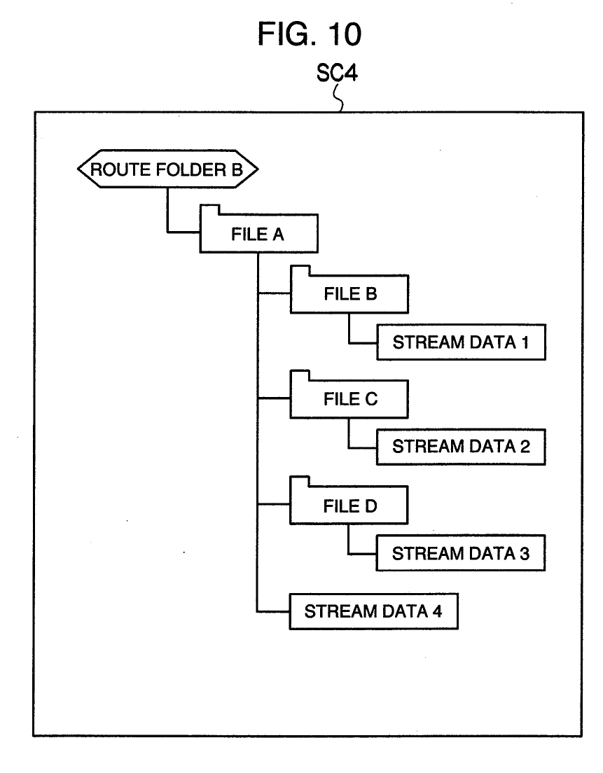

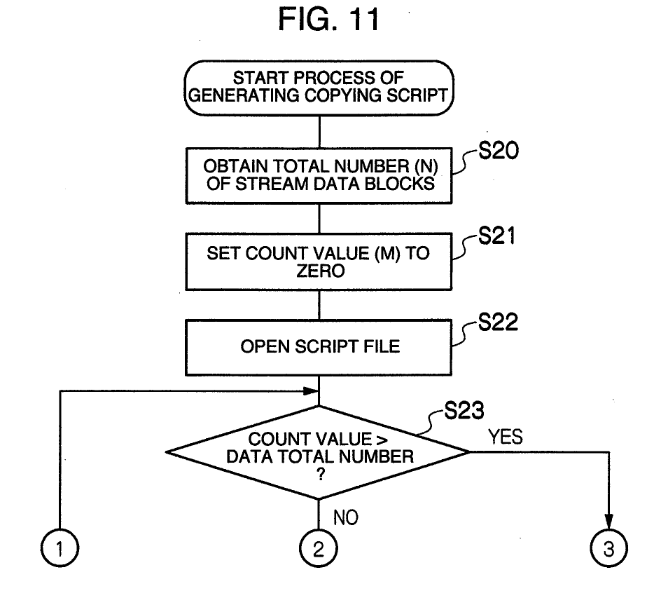

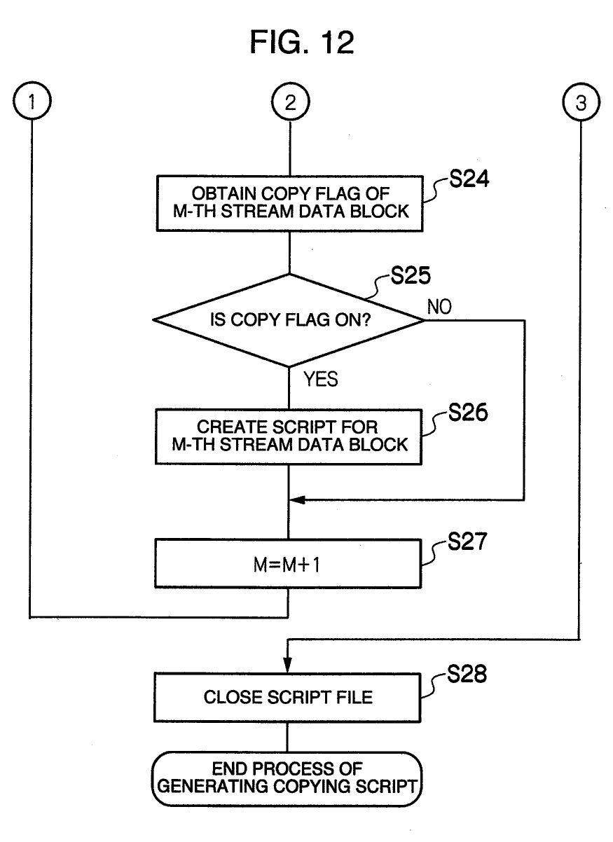

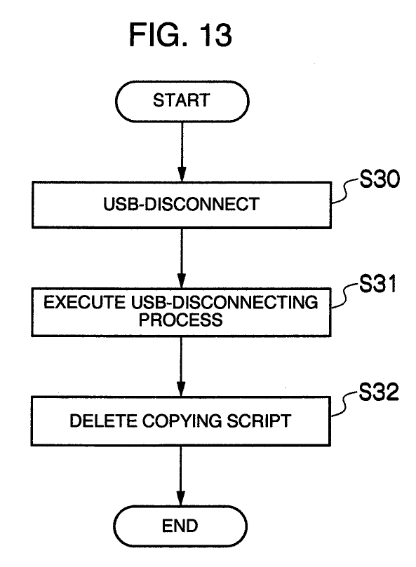

On the other hand, FIG. 10 shows a route holder B opened the personal computer 300. The route folder B concerns with the case that the user of the personal computer recognizes on the screen SC4 that a removable disk is connected to the personal computer 300. The user of the personal computer 300 can check the stream data blocks 1 to 4 saved in the ordinary files A to D but cannot check the script file 250.

If the personal computer 300 determines the script file 250 is created (Yes in S12), the personal computer 300 executes the copying script 260 created in the script file 250 (S13). That is, the backup copy of the stream data block 240 is created by the personal computer 300 at the operation mode set by the information device 100.

After the backup copy is created, the personal computer 300 finishes the USB-connecting process (S14).

If the personal computer 300 determines that the script file 250 is not created (No in S12), the personal computer 300 finishes the USB-connecting process (S14).

As described above, when a specific device is connected with the personal computer 300, the personal computer enables to execute the copying script 260 saved in the script file (for example, Autorun.inf) 250 stored in a specific location of the information device.

(6) Process of Generating a Copying Script

In turn, the process of creating the copying script 260 in the step S3 will be described in detail. The CPU 230 of the information device 100 starts a program 233 for generating the copying script and a program 232 for controlling a copy flag.

At first, the CPU 230 obtains a total number of stream data blocks 240 selected by the user (S20). Herein, if the user selects the “copy of all scenes” item 521 as the operation mode, the total number N corresponds to the total number of all stream data blocks 240. Further, if the user selects the “copy of an uncopied scene(s)” item 523 as the operation mode, the total number N corresponds to the total number of the selected stream data block(s) 240.

In turn, the PU 230 sets a count value of the stream data block 240. The CPU 230 sets a value of zero as an initial count value M.

Afterwards, the CPU 230 opens an empty script file 250 (S22).

The CPU 230 compares the count value M with the total number N of the stream data blocks. If the count value M is smaller than the total number N (No in S23), the CPU 230 obtains a status of the copy flag of the stream data block 240 registered at the M-th location in the copying management table 235 (S24).

If the CPU 230 determines that the status of the obtained copy flag is ON (Yes in S25), the CPU 230 creates the script for copying the stream data block 240 at the M-th location into the personal computer 300 (S26).

After the script is created or if it is determined that the status of the obtained copy flag is OFF (No in S25), the CPU 230 increase the count value by one (S27) and then performs the process of the step S23 again.

On the other hand, if, in the step S23, the count value M is more than or equal to the total number N (Yes in S23), since the creation of the copying script 260 of the stream data 240 is finished, the CPU 230 closes the script file 250 (S28) and then finishes the process of creating the copying script.

In turn, the description will be oriented to the process of disconnecting a USB cable 220. The CPU 230 causes the copying script generating program 233 to carry out the disconnecting process.

At first, the user manually disconnects the USB cable 220 (S30).

In response to the user's disconnection, the information device 100 starts the process of disconnecting the USB cable 220 (which will be referred simply to as a “USB disconnection” in noun form or “USB-disconnect” in verb form). Concretely, the USB interface 201 of the information device 100 detects the disconnection of the USB cable 202, the USB interface 201 and the USB mass storage 202 stops the process being executed during the USB connection and then prepares for the coming USB connection.

Afterwards, the information device 100 deletes the copying script 260 by deleting the script file 250 created when it is USB-connected with the personal computer 300 (S32) and then finishes the USB-disconnecting process.

As described above, the execution of the programming process makes it possible to generate the copying script 260 at the operation mode to be determined each time the device is USB-connected with the personal computer 300. If the user does not select the “automatic copy OFF” item 520, the copying script 260 is not generated. Further, the copying script 260 may be automatically deleted by the information device 100 at the USB-disconnecting time. The copying script 260 cannot be deleted on the host side, that is, by the personal computer 300 or the user.

In the foregoing description, the operation mode has been determined before the connection of the USB cable 20. Instead, it may be determined thereafter.

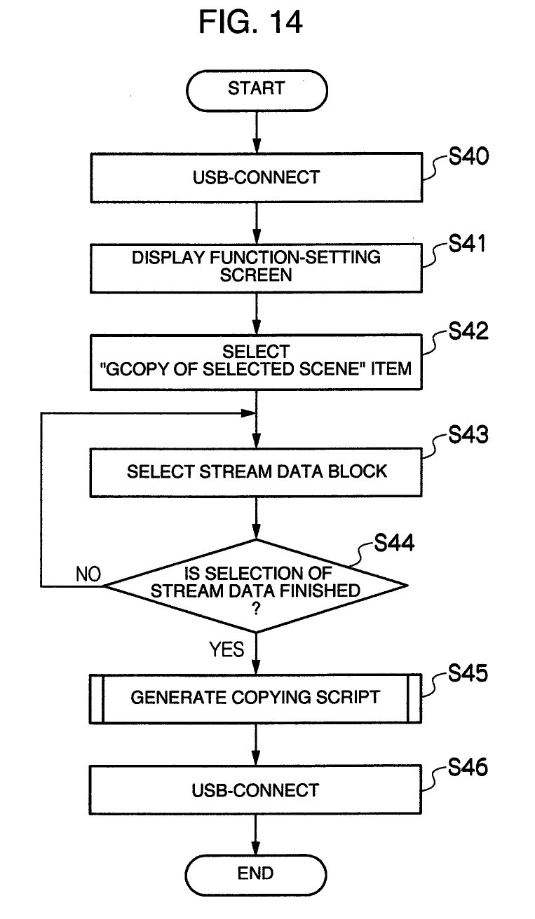

Concretely, as shown in FIG. 14, after the information device 100 is USB-connected with the personal computer 300 (S40), the information device 100 causes the monitor 111 to display the screen SC1 for setting a function (S41) so that the user can select the “copy of a selected scene” item 522 (S42).

Then, the information device 100 keeps the stream data block 240 to be copied selecting until the user finishes the selection of any stream data block 240 (S43, S44).

Afterwards, the processes of the steps S45 and S46 are executed in the similar manner to the foregoing processes of the steps S3 and S4 by the information device 100.

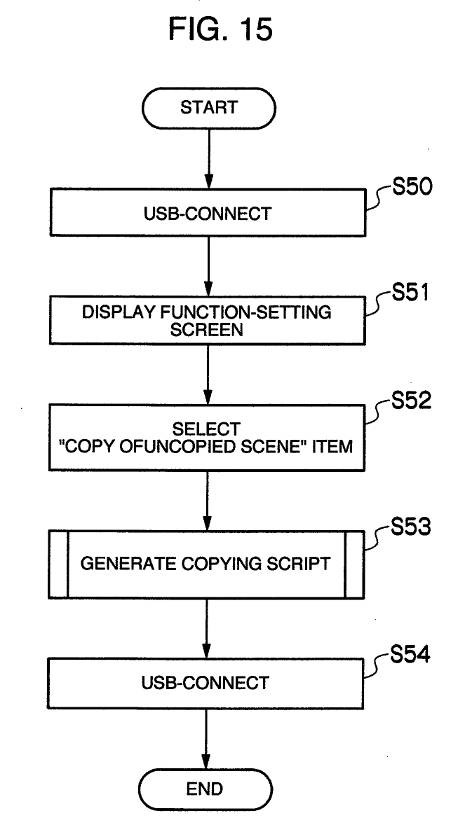

Further, as shown in FIG. 15, after the information device 100 is USB-connected with the personal computer 300 (S50), the information device 100 causes the monitor 111 to display the screen SC1 for setting a function (S51) so that the user can select the “copy of an uncopied scene” item 523 (S52).

Afterwards, the processes of the steps S53 and S54 are executed in the similar manner to the foregoing processes of the steps S3 and S4 by the information device 100.

If the recording medium takes a VR format as is often used in DVD-RAM, the file is not divided for each stream data block (scene) 240. Hence, if the file copy for each scene is required as in the function such as the “copy of a selected scene” or the “copy of an uncopied scene”, what is required to implement the present invention is a dividing process to be executed when the information device 100 is USB-connected with the personal computer 300. In addition, if the recording medium takes a BD (Blue-ray Disc) or DVD-video format, the foregoing process is not required because the file is divided for each scene.

(7) Effect of this Embodiment

This embodiment is effective in that the target data block, which is selected among the data blocks stored in the information device to be recognized as a detachable device by the personal computer, is copied in a memory loaded in the personal computer for the backup purpose.

(8) The others

The information device 100 provides a capability of recording inputted image and sound data in the HDD 109 and reproducing the recorded data. Moreover, when recording the image and sound data, the information device 100 also provides a capability of recording and reproducing the data according to the standards defined by each recording medium.

In the foregoing description, the management tables 234 and 235 have been stored in the memory 231. Instead, those tables may be stored in the HDD 109.

The HDD 109 may be built in the information device or detached therefrom. If the HDD 109 is detachable, the data recorded in the HDD 109 may be carried by the user, so that the data may be easily transferred to another device.

Moreover, the recording medium to be used for the present invention may be a memory or a storage unit rather than the HDD 109. As another concrete recording medium, an optical disk drive such as a DB or a DVD or a semiconductor memory such as an SD memory card may be referred. One or more semiconductor memories may be loaded in the information device 100.

Further, as a means of transferring data may be used another general-purpose peripheral device interface rather than the USB interface.

It should be further understood by those skilled in the art that although the foregoing description has been made on embodiments of the invention, the invention is not limited thereto and various changes and modifications may be made without departing from the spirit of the invention and the scope of the appended claims.

1. An information recording and reproducing device for recording or reproducing one or more stream data blocks, comprising:
means for setting an operation mode about whether or not and how a backup data copy of the stream data blocks is created onto an external device; and
means for generating a script for executing a copy of only the backup data block(s) selected at the operation mode if the backup data copy is created onto the external device.

2. The information recording and reproducing device as claimed in claim 1, wherein when connected with the external device or the setting means sets the operation mode, the script is executed to transfer the backup data selected at the operation mode to the external device.

3. The information recording and reproducing device as claimed in claim 1, wherein the operation mode includes at least two of a mode about a copy of all of the one or more stream data blocks, a mode about a copy of a stream data block(s) selected from the one or more stream data blocks, a mode about a copy of an uncopied stream data block(s) of the one or more stream data blocks, and a mode about no copy of all the one or more stream data blocks.

4. The information recording and reproducing device as claimed in claim 1, wherein when connected with the external device, the operation mode is set.

5. The information recording and reproducing device as claimed in claim 1 being connected with the external device through a USB (Universal Serial Bus) interface.

6. A copying method for backing up one or more stream data blocks stored in an information recording and reproducing device for recording or reproducing the one or more stream data blocks, comprising the steps of:
setting an operation mode about whether or not and how a backup data copy of the one or more stream data blocks is created onto an external device; and
generating a script for executing a copy of the backup data selected at the operation mode if the backup data copy is created onto the external device.

7. The copying method as claimed in claim 6, further comprising the steps of:
executing the script when the information recording and reproducing device is connected with the external device or the operation mode is set in the setting step; and
transferring the backup data selected at the operation mode to the external device.

8. The copying method as claimed in claim 6, wherein the operation mode includes at least two of a mode about a copy of all the one or more stream data blocks, a mode about a copy of a stream data block(s) selected from the one or more stream data blocks, a mode about a copy of an uncopied stream data block(s) from the one or more stream data blocks, and a mode about no copy of all the one or more stream data blocks.

9. The copying method as claimed in claim 6, wherein in the setting step the operation mode is set when the information recording and reproducing device is connected with the external device.

10. The copying method as claimed in claim 6, wherein the information recording and reproducing device is connected with the external device through a USB interface.
